(19) United States
(12) Patent Application Publication
(10) Pub. No.: US 2025/0392770 A1
(43) Pub. Date: Dec. 25, 2025

(54) Method for managing access, by a playback device, to multimedia content after sound has been muted

(71) Applicant: Orange, Issy-les-Moulineaux (FR)

(72) Inventors: Hervé MARCHAND, CHATILLON CEDEX (FR); Olivier GASTE, CHATILLON CEDEX (FR)

(21) Appl. No.: 19/241,561

(22) Filed: Jun. 18, 2025

(30) Foreign Application Priority Data
Jun. 19, 2024 (FR) FR2406541

(51) Int. Cl. H04N 21/239; H04N 21/472

(52) U.S. Cl. CPC H04N 21/2396; H04N 21/47217

(57) ABSTRACT

A method for managing access, by a playback device, to multimedia content including audio and video segments that are downloaded successively with a view to being rendered. Reception of a datum representative of sound being muted by the playback device results in stoppage of the downloading of the audio segments.

### CROSS-REFERENCE TO RELATED APPLICATIONS

This application claims priority to and the benefit of French Patent Application No. FR2406541, filed Jun. 19, 2024, the contents of which are incorporated herein by reference in their entireties.

### TECHNICAL FIELD

The present disclosure relates to the field of telecommunications.

The present disclosure relates to a method for managing access, by a playback device, to multimedia content after sound has been muted.

A playback device is understood to mean devices capable of receiving a multimedia stream and of requesting rendering of the content on a rendering device.

### PRIOR ART

When accessing multimedia content, the playback device sends a request to a content server indicating the chosen multimedia (video and/or audio) content. The playback device receives, in return, a digital data stream relating to this content. The received data are then decoded by the playback device, and then rendered.

In the case of audiovisual content, the rendering is effected in the form of a display of the corresponding video with its associated soundtrack.

The broadcasting of multimedia content over the Internet is often based on client-server protocols of the HTTP (Hypertext Transport Protocol) family. In particular, streaming content makes it possible to transport and play back data in real time, that is to say that the digital data are transmitted over the network and received by the playback device as they arrive. Following reception of the stream, the playback device stores received data in a buffer memory before rendering them. This distribution mode is particularly useful when the bit rate available to the user is not guaranteed to be enough for real-time transfer of the video.

HTTP adaptive streaming, HAS for short, additionally makes it possible to broadcast and receive data with various qualities corresponding, for example, to various respective encoding bit rates. These various qualities are described in a description file, called the manifest.

When a user accesses the live stream broadcast via HTTP adaptive streaming (HAS), the playback device, via an HAS download management entity, retrieves successively, at regular intervals, in general every two seconds, manifests that generally each describe the last sixty seconds of the stream (30 segments of 2 seconds) by providing addresses of segments corresponding to these last sixty seconds. This manifest includes URLs of the downloadable segments.

When playing back multimedia content in adaptive streaming mode, the playback device, i.e. the HAS download entity, regularly retrieves audio segments and video segments using network addresses (for example URLs, URL standing for Uniform Resource Locator) of the segments described in the last received manifest, respectively.

The audio and video segments are downloaded at roughly the same rate and the playback device takes responsibility for storing in memory (a person skilled in the art makes reference to “buffering”) the audio segments and video segments received by the playback device at one and the same buffer depth. This buffer memory will also be referred to as a buffer throughout the present text.

Therefore, when playing back audio and/or video content, it is possible for the user to set the audio output to mute in order to completely mute the sound.

The inventors have found that, after sound has been muted, the playback device continues to download audio segments unnecessarily. These unnecessary downloads take up bandwidth in the network of the telecommunications operator on which the segments are downloaded, this being undesirable.

One or more exemplary aspects of the present disclosure aim to improve the situation.

### SUMMARY

To this end, an exemplary aspect of the present disclosure relates to a method for managing access to successively downloaded audio segments of multimedia content, the segments being intended to be received by a playback device with a view to being rendered acoustically, characterized in that reception of a datum representative of sound being muted by the playback device during playback of the content results in stoppage of the reception of audio segments.

According to an aspect of the present disclosure, when sound is muted, the playback device stops receiving the audio segments; said audio segments are no longer downloaded unnecessarily, thereby improving the bandwidth on the network over which the segments are downloaded. It will be seen hereinafter that, when the content is audiovisual content, the playback device continues to play back the content solely on the basis of the downloaded video segments.

According to a first particular mode of implementation of an aspect of the present disclosure, sound being muted results in stoppage of the transmission of requests to access the audio segments. This first mode is a simple way of stopping the transmission of audio segments by stopping the messages requesting segments. It should be noted that, in this first mode, the stoppage may concern all or some of the audio access requests.

According to a second particular mode of implementation of an aspect of the present disclosure, which may be implemented as an alternative or in addition to the previous one, following sound being muted, the content continues to be played back by playing back a substitute audio segment. This mode is beneficial when the content is audiovisual content and when the playback device is able to play back the content only if both audio and video segments are recorded in the buffer of the playback device. In this second mode, since the playback device no longer downloads audio segments, the substitute segment allows the playback device to fill the audio buffer and to continue playing back segments on the basis of a downloaded video segment and the substitute segment; the latter may be the same audio segment used each time video segments are played back; the chosen substitute segment may also be different each time a segment is played back. This second mode avoids abrupt stoppage of the playback caused by the stoppage of the downloading of the audio segments, and therefore an empty audio buffer.

According to a first variant of the second mode, the substitute segment is a segment downloaded and stored in the playback device before sound is muted. In most playback devices, multiple segments are stored in an audio buffer before being played back and then erased after playback; indeed, in some playback devices, once playback has begun, the playback device seeks to fill a buffer with a data level that reaches around twenty seconds, i.e. roughly ten segments of two seconds. The substitute segment may be chosen from the last ten segments stored.

According to a second variant of the second mode, before sound is muted, a segment may be erased after playback; in this configuration, following the muting, the method comprises preventing erasure of a downloaded audio segment and using this segment as a substitute segment. Picking up on the above example of ten segments of ten seconds, the substitute segment may be chosen from the last ten segments stored.

According to one sub-variant of this second variant, preventing erasure comprises intercepting an erasure command. Once it has been intercepted, the command is not executed and the segment targeted for erasure is not erased and may be used as a substitute audio segment when the content continues to be played back.

According to a third embodiment of the disclosure, which may be implemented as an alternative or in addition to the previous ones, the content furthermore includes video segments; in this case as indicated above, after the audio segments have stopped being downloaded, the content continues to be played back by downloading and playing back the video segments.

According to one hardware aspect, the disclosure relates to an entity for managing access, by a playback device, to multimedia content comprising audio and video segments that are downloaded successively with a view to being rendered, characterized in that it comprises a reception module able to receive a datum representative of sound being muted by the content playback device and a stopping module able, following reception of the datum representative of sound being muted, to bring about stoppage of the downloading of the audio segments.

According to another hardware aspect, the disclosure relates to a playback device, characterized in that it comprises a management entity as defined above.

According to another hardware aspect, the disclosure relates to a computer program able to be implemented in a management entity as defined above, said program comprising code instructions that, when the program is executed, perform the step defined in the method defined above.

According to another hardware aspect, the disclosure relates to a recording medium able to be read by a data processor and on which is recorded a program comprising program code instructions for executing the steps of the method defined above.

It should be noted here that the data medium may be any entity or device capable of storing the program. For example, the medium may include a storage means, such as a ROM, for example a CD-ROM or a microelectronic circuit ROM, or else a magnetic recording means, or a hard disk. On the other hand, the information medium may be a transmissible medium such as an electrical or optical signal, which may be routed via an electrical or optical cable, by radio or by other means. The program according to an aspect of the present disclosure may, in particular, be downloaded over the Internet. As an alternative, the information medium may be an integrated circuit into which the program is incorporated, the circuit being designed to execute or to be used in the execution of the method in question.

### BRIEF DESCRIPTION OF THE DRAWINGS

The disclosure will be better understood on reading the following description, which is given by way of example and with reference to the appended drawings, in which:

FIG. 1 shows a computer system in which an aspect of the present disclosure may be implemented.

FIG. 2 is a schematic view of the circuits present in the playback device.

FIG. 3 is an algorithm illustrating a series of steps implemented according to one possible aspect of the disclosure in which the accessed content is audio and video content.

### DETAILED DESCRIPTION OF ONE EXEMPLARY ASPECT OF THE DISCLOSURE

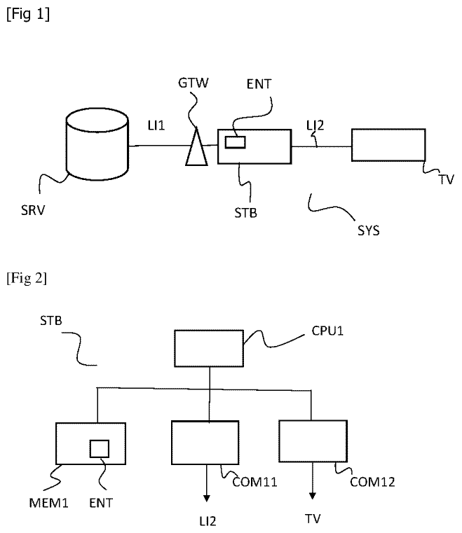

FIG. 1 shows a computer system SYS in which a content distribution network (CDN) is implemented from which content is transmitted to client devices or content playback devices and manifests associated with the multimedia content are transmitted. The content broadcast server, called a content server in the present text, broadcasts on multiple broadcast channels associated with television channels.

In our example, to simplify the disclosure, the system SYS comprises a single playback device STB. However, the disclosure applies to any number of playback devices, the principle of the disclosure being able to be implemented on all or some of the playback devices STB.

The playback device STB is a digital-content playback device, such as a set-top box.

The multimedia content in question here is audio and/or video content. Audio content is for example a radio programme, and video content is for example a television channel. The content is broadcast from one or more servers, which are described below. It will be seen hereinafter that the disclosure applies equally to audio content and to audiovisual content.

In our example, the playback device STB is connected to a rendering terminal TV such as a television. The device may transmit data to be rendered to the rendering device TV. A command to mute sound makes it possible to mute sound on this rendering device TV. The command may come from a remote command received directly by the rendering device TV or via the playback device STB.

In our example, the playback device STB is connected to a port of the rendering device TV; the playback device STB and the rendering device TV could also form one and the same device.

In our example, the playback device STB is located in a local area network LAN managed by a home gateway GTW.

The gateway GTW is able to communicate via a communication link LI1, which may be a telecommunications network such as a wide area network WAN known to a person skilled in the art.

In our example, the computer system SYS implements a content distribution network (CDN) from which content is transmitted to content playback devices STB.

The network CDN consists of servers that are networked in the wide area network; these servers cooperate in order to make multimedia content available to users. In order to simplify the disclosure, a single content server SRV will be shown in FIG. 1 to represent the CDN. The content server SRV is located, in our example, in the wide area network WAN.

The content server SRV receives, for example, channels of digital-television content originating from a television broadcast network (not shown) and makes them available to client terminals, here the playback device STB, in real time via broadcast channels.

FIG. 2 shown an architecture of a playback device STB. This device STB comprises, as is conventional, memories MEM1 associated with a processor CPU1. The memories may be read-only memories (ROMs) or random access memories (RAMs) or indeed flash memories.

The playback device STB may transmit content to be rendered to the rendering device TV via a communication module COM12. This module COM12 is for example an HDMI link LI2.

The playback device STB communicates with the gateway via an Ethernet module for wired local communication or via a Wi-Fi radio module for wireless local communication with the home gateway GTW. The module in question is referenced COM11 in FIG. 2.

In our example, the playback device STB comprises an HAS (HTTP adaptive streaming) streaming mode download management module, not shown, able to manage the downloading of segments of the content when the content is transmitted over the network LI1 in the form of segments in accordance with the technique known as adaptive streaming, which is known to a person skilled in the art.

It will be recalled briefly here that, when a user accesses a live stream broadcast via HTTP adaptive streaming (HAS), the playback device STB successively receives, at regular intervals, for example every two seconds, manifests that generally each describe the last sixty seconds of the stream (30 segments of 2 seconds) by providing URL addresses of segments corresponding to these last sixty seconds. Using the received segment addresses, the playback device STB is able to download the segments to a memory MEM1 (an audio buffer for the audio part and/or a video buffer for the video part), decode them and play them back one after another for rendering on the rendering device TV.

The server SRV is also equipped with at least one processor and with memories for carrying out electronic data processing. The server SRV communicates with the gateway GTW via a WAN.

The steps according to one embodiment are described below.

When the playback device STB accesses the content to play it back, the steps are as follows:
The HAS entity accesses the segments successively by transmitting a download request for each segment. The requests for audio and video access are generally transmitted substantially at the same time and are also received by the playback device STB at roughly the same time;
After reception, the playback device STB stores a certain number of audio and/or video segments in a RAM memory (an audio buffer and a video buffer) and decodes the segments so that they are be able to be rendered on the rendering device TV.

Once they have transmitted to the rendering device TV, the segments are erased from the RAM memory.

Following sound being muted on the rendering device TV, according to the an aspect of the present disclosure, the playback device STB no longer receives the audio segments.

It will be seen hereinafter that, in the case of audiovisual content, playback continues only on the basis of downloaded video segments.

In our example, the audio segments stop being received by the playback device STB by virtue of requests to access the audio segments no longer being transmitted. According to one variant, the audio segments could also stop being received by the playback device STB by virtue of transmitting a request to stop the transmission of the audio segments to the server SRV.

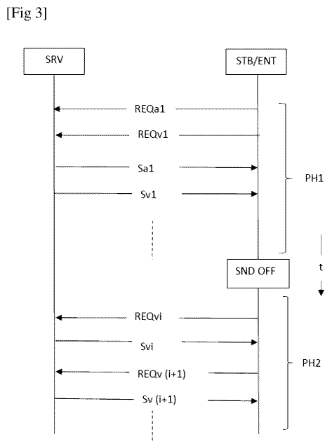

FIG. 3 illustrates one aspect of the method of the disclosure based on audiovisual content.

In this FIG. 3:
Requests to access the audio segments will be referenced REQai;
Requests to access the video segments will be referenced REQvi;

These requests include URLs for accessing an audio segment Sai and a video segment Svi, respectively.
Audio segments will be referenced Sai;
Video segments will be referenced Svi;
The index “i” designates the nth segment.

This FIG. 3 shows two axes associated with the server SRV and with the playback device STB including the management entity ENT. Arrows represent data exchanges between the two entities. It should be noted that the time differences between the times when requests are sent or the times when segments are sent are not representative of reality; the example illustrated is simplified so as to highlight the principle of the disclosure, namely stopping the reception of audio segments following sound being muted.

This FIG. 3 illustrates two main phases: a first phase PH1 of playing back the content before sound is muted, and a second phase PH2 of playing back the content after sound has been muted.

In the first phase PH1 preceding sound being muted, the playback device STB transmits successive requests to access the audio and video segments: a first request REQa1 and RQv1 and receives, in return, an audio segment a1 and a video segment v1; this continues in the same way, with the playback device STB transmitting requests and receiving the requested segments in return (not shown in the figure since it is of no interest to the disclosure of the disclosure). Only requests to access the first segment are shown in the figure to simplify the disclosure.

It is now assumed that a user of the rendering device TV mutes the sound. This step is referenced SND OFF in FIG. 3.

The second phase PH2 comprises the following steps:

The playback device STB, i.e. the management entity ENT, first receives a datum representative of sound being muted, and executes the following steps.

Upon reception of the datum relating to sound being muted, the entity ENT requests stoppage of the transmission of requests to access the audio segments. In our example, the playback device STB then continues playback by transmitting successive requests to access video segments only; in FIG. 3, a request to access a video segment REQvi is transmitted and a video segment Svi is received in return, and so on for a request REQv(i+1) and a segment Vi+1, etc.

Another way of not receiving audio segments could also be to intercept requests to access audio segments and prevent the respective transmissions thereof to the server storing the audio segments.

It is now assumed, according to one particular aspect of the present disclosure, that the HAS management entity plays back the content only if there is both an audio segment and a video segment in the respective buffers and that, if not, playback is blocked and content cannot be rendered.

In order to continue playback without interruption, one or more substitute audio segments are recorded in the audio buffer; for example, if the HAS entity has to record ten audio segments in the buffer to guarantee playback, the ten segments are replaced for example by the same substitute segment; the segments recorded in the buffer may also be reused.

Since the substitute audio segments and the downloaded video segments are recorded in the audio and video buffers, the HAS entity is able to play back the segments and request rendering of the segments on the rendering device TV.

In other words, the audio segments that should have been downloaded are replaced by other substitute audio segments. A substitute segment may be chosen in several ways, as follows:

In a first way, the substitute segment is the last segment received by the playback device STB. Instead of being erased after it has been played back from the audio buffer, the management entity ENT prevents the segment from being erased from the audio buffer. This mode makes it possible to keep, in the audio buffer, a substitute audio segment that is able to be reused multiple times during the playback of successive video segments.

According to a second variant, following sound being muted, the audio segments downloaded to the audio buffer are not erased after playback. These audio segments may be reused during the playback of the content in place of the segments that should have been downloaded and described in the last manifest received after sound was muted. In other words, after sound has been muted, the audio segments described in the manifests are not used and are replaced by substitute segments. The player therefore does not take into account the URLs of the audio segments.

The prevention in question above may consist in intercepting an erasure command so that it is not executed by the processor of the playback device STB. This prevention makes it possible to keep, in the audio buffer, the downloaded segments in order to reuse them as desired during the playback of the content.

It should be specified here that, in our example, the audio segment is received and recorded in an audio buffer; the segment player installed in the playback device STB is, in our example, an “adaptive streaming” player executed in a Web browser. This player manages not only storage in the audio buffer but also storage of a number of segments sufficient to ensure seamless playback of the content; generally, the buffer depth is fifteen to twenty seconds.

Preferably, a substitute segment is a segment that has been already decoded and is ready to be transmitted for rendering. This mode avoids decoding the substitute segment each time playback of this segment is requested; this makes it possible to reduce the processor resource of the playback device STB each time a segment is played back.

It should be noted that, when sound is reactivated, the downloading process resumes as normal by downloading both audio and video segments until the next muting, if any.

It should also be noted here that the term segment refers, in the embodiment, to HAS segments; however, the disclosure extends to any type of similar segments.

Lastly, it should be noted here that, in the present text, the term “module” or “entity” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly capable of implementing a function or a set of functions for the module in question (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A management method for managing access, by a playback device, to multimedia content comprising audio and video segments that are downloaded successively with a view to being rendered, wherein the method is implemented by a management entity device and comprises:
receiving a datum representative of sound being muted by the playback device; and
stopping downloading of the audio segments in response to receiving the datum.

2. The management method according to claim 1, the stopping downloading comprises stopping transmission of requests to access the audio segments.

3. The management method according to claim 1, wherein, following sound being muted, the content continues to be played back by playing back a substitute audio segment.

4. The management method according to claim 3, wherein the substitute segment is a segment downloaded and stored in the playback device before sound is muted.

5. The management method according to claim 3, wherein the method comprises, following sound being muted, preventing erasure of a downloaded audio segment after playback and using this segment as a substitute segment.

6. The management method according to claim 5, wherein preventing erasure comprises intercepting an erasure command.

7. The management method according to claim 4, wherein the substitute segment is a segment that has been decoded.

8. The management method according to claim 1, wherein, following the stoppage, the content continues to be played back by downloading and playing back the video segments.

9. A management entity device for managing access, by a playback device, to multimedia content comprising audio and video segments that are downloaded successively with a view to being rendered, wherein the management device comprises:
at least one processor; and
at least one non-transitory computer readable medium comprising instructions stored thereon which when executed by the at least one processor configure the management entity device to:
receive a datum representative of sound being muted by the content playback device; and
following reception of the datum representative of sound being muted, to bring about stoppage of the downloading of the audio segments.

10. A playback device comprising the management entity device as defined in claim 7.

11. A non-transitory recording medium able to be read by a data processor and on which is recorded a program comprising program code instructions which, when executed by the data processor, configure the data processor to implement a method for managing access, by a playback device, to multimedia content comprising audio and video segments that are downloaded successively with a view to being rendered, wherein the method comprises:
receiving a datum representative of sound being muted by the playback device; and
stopping downloading of the audio segments in response to receiving the datum.
